(19) United States
(12) Patent Application Publication
(10) Pub. No.: US 2025/0135920 A1
(43) Pub. Date: May 1, 2025

(54) HIGH VOLTAGE POWER MANAGEMENT MODULE

(71) Applicant: Viritech Ltd, London (GB)

(72) Inventor: Matthew Robert FAULKS, Buckinghamshire (GB)

(73) Assignee: Viritech Ltd, London, LN (GB)

(21) Appl. No.: 18/683,073

(22) PCT Filed: Dec. 8, 2022
(86) PCT No.: PCT/GB2022/052111

§ 371 Date: Feb. 12, 2024

(30) Foreign Application Priority Data
Aug. 12, 2021 (GB) 202111618

(51) Int. Cl. B60L 50/75; B60L 15/00; B60L 15/20; B60L 58/40; H01M 8/04858; H01M 10/42; H01M 10/44; H01M 16/00

(52) U.S. Cl. CPC B60L 50/75; B60L 15/007; B60L 15/2045; B60L 58/40; H01M 8/04925; H01M 10/425; H01M 10/44; H01M 16/006; B60L 2210/10; B60L 2210/40; H01M 2010/4271; H01M 2220/20; H01M 2250/20; H01M 2250/402

(57) ABSTRACT

A high voltage power management module for supplying power to one or more motors for driving a fuel cell electric vehicle. The high voltage power management module comprises an E-Machine interface subsystem for exchanging DC power with an inverter configured to provide AC power to one or more motors for driving a drivetrain of the vehicle. The high voltage power management module further comprises a storage interface subsystem to exchange DC power with an electrical energy store for providing transient power to drive the fuel cell electric vehicle. The high voltage power management module further comprises a fuel cell interface subsystem for receiving DC power from a fuel cell stack of the vehicle configured to directly drive the one or more motors through the E-Machine interface subsystem of the high voltage power management module.

### TECHNICAL FIELD

The present disclosure relates to high voltage power management modules. In particular, the present disclosure relates to high voltage power management modules for supplying power to one or more motors for driving a fuel cell electric vehicle.

### BACKGROUND

The depletion of fossil fuels and the detrimental effects of fossil fuels on the environment have resulted in endeavours to transition away from the use of such fuels in vehicles.

Electric vehicles have been developed that use little or no fossil fuel, meaning they generate less and sometimes no emissions or pollutants when used, and so are less damaging to the environment. Electric vehicles use electrical energy stores such as electrochemical secondary cells to store electrical energy for later emission-free conversion as a source of electrical power, for example to drive electrical motors to propel vehicles.

However, such electrical energy storage is not without drawbacks in that, in automotive applications for example, the range currently achievable using electric vehicles with electrical energy storage is typically limited to 100-200 miles using a full charge. To replenish the charge stored in the electrical energy store, the vehicles need to be connected to an external power point, and these power points are only in specific locations, presenting difficulties for long-distance travel. Moreover, the time required to replenish the charge stored in the electrical energy store is large which also presents difficulties for long-distance travel. Further still, large lithium batteries are required to power electric vehicles and these batteries contain large amounts of lithium. The supply of lithium that is needed for electrical energy stores such as secondary cells may not be able to keep pace with increased demand for battery storage over the coming years. Thus, the lack of suitability of electrical energy storage for all applications, and the anticipated constraints on supply mean that viable alternative stores of energy are needed if we are to successfully transition away from fossil fuels.

Instead of recharging at an external power point, an alternative means of recharging the electrical energy store is using hydrogen, which can be converted to electrical energy on demand by passing it over an electrolytic membrane in a stacked fuel cell, which can then be used as a source of power to the electrical energy store. The conversion of stored hydrogen to electrical energy in a fuel cell produces only heat and water as by-products, and as a result is completely carbon-free and does not produce other pollutants at the point of use. Further, processes to produce hydrogen using green energy from renewable sources are being commercialised that provide a means for hydrogen to become a zero carbon source of power for transportation and local electricity generation. Fuel cells can continue in their operation for as long as there is a supply of hydrogen from a source, which is typically stored in a storage tank that can be replenished quickly at refuelling stations. Thus, fuel cells can provide continuous power, for example, for long range travel with short downtimes for refuelling, in vehicular applications.

It is in this context that the presently disclosed subject matter is devised.

### BRIEF SUMMARY OF THE DISCLOSURE

Whilst the use of fuel cells to recharge the electrical energy store reduces the amount and duration of refuelling, these cells are both very large and heavy and so a combination of these cells provides a large and heavy vehicle, which is therefore inefficient.

Thus, viewed from one aspect, the present disclosure provides a high voltage power management module for supplying power to one or more motors for driving a fuel cell electric vehicle. The high voltage power management module comprises an E-Machine interface subsystem for exchanging DC power with an inverter configured to provide AC power to one or more motors for driving a drivetrain of the vehicle. The high voltage power management module further comprises a storage interface subsystem to exchange DC power with an electrical energy store for providing transient power to drive the fuel cell electric vehicle. The high voltage power management module further comprises a fuel cell interface subsystem for receiving DC power from a fuel cell stack of the vehicle configured to directly drive the one or more motors through the E-Machine interface subsystem of the high voltage power management module. The high voltage power management module further comprises a switching module configured to direct the voltage between the DC power of the storage interface subsystem, the fuel cell interface subsystem and the E-Machine interface subsystem, wherein the switching module is configured to be operable to rapidly switch between or simultaneously combine DC power from the storage interface subsystem and the fuel cell interface subsystem to provide DC power to the E-Machine interface subsystem to drive the one or more motors for driving a drivetrain of the vehicle. The high voltage power management module further comprises control circuitry coupled to the switching module to control the switching module to select or combine a source of DC power from the electrical energy store and the fuel cell stack to provide DC power to the E-Machine interface subsystem.

Using the fuel cell to drive the motor without first charging the electrical energy store means the electrical energy store is no longer needed when the fuel cell is powering the motor and so a large electrical energy store is not required in order to store all power from the fuel cell before it is used to power the motors. However, the fuel cell may be limited in its power output or in its speed in scaling up the power output such that, when a high power output is required, for example, during acceleration, the fuel cell may not be able provide the required power.

Therefore, an electrical energy store is provided to enhance the power provided by the fuel cell when the vehicle requires a high power output. As the high power is not required for an extended period, the electrical energy store does not need to have a high capacity. The present disclosure therefore enables the capacity of the electrical energy store to be reduced, as it is not required to store all power from the fuel cell before it is used to power the motors. Reducing the capacity of the electrical energy store reduces the size and the weight of the store, and consequently the weight of the vehicle can be reduced such that the vehicle requires less power to run and is more efficient. Moreover, reducing the size of the electrical energy store reduces the amount of lithium required for the store. As hydrogen fuel cells do not require lithium, the present disclosure requires less lithium and so is more sustainable. The switching module enables the power supply to the motor to be received from the fuel cell and/or the electrical energy store to provide a flexible power management system of a reduced size and weight. Such a power management system provides increased vehicle performance and efficiency with reduced vehicle mass and lithium consumption. In fact, in comparison to conventional lithium battery electric vehicles, the present disclosure provides a ten fold reduction in energy store mass and lithium consumption.

According to another aspect of the invention a DC-DC converter is provided. The DC-DC converter comprises a high voltage power management module described herein. The switching module is further configured to step the voltage between the DC power of the storage interface subsystem, the fuel cell interface subsystem and the E-Machine interface subsystem, and to be operable to rapidly switch between or simultaneously combine DC power from the storage interface subsystem and the fuel cell interface subsystem to provide converted DC power to the E-Machine interface subsystem to drive the one or more motors for driving a drivetrain of the vehicle. The control circuitry is further configured to control the switching module to select or combine a source of DC power from the electrical energy store and the fuel cell stack to provide converted DC power to the E-Machine interface subsystem.

According to another aspect of the invention an electrical energy store is provided. The electrical energy store is for use with a high voltage power management module as described herein for supplying power to one or more motors for driving a fuel cell electric vehicle or the electrical energy store is for use with a DC-DC converter as described herein. The electrical energy store is configured to have a maximum charge capacity, and a peak deployable output power such that, when operating at peak deployable output, the electrical energy store is discharged from its maximum charge capacity to depletion in less than 5 minutes.

According to another aspect of the invention a vehicle control unit, VCU, is provided. The VCU is for use with a high voltage power management module as described herein or a DC-DC converter as described herein. The VCU has an input to receive a torque signal indicative of a requested torque to be provided to a drivetrain of the vehicle. The VCU has an output to provide control signals to a high voltage power management module as described herein or a DC-DC converter as described herein. The VCU has a control module configured to provide at the output control signals for the high voltage power management module or DC-DC converter indicating whether to select or combine a source of power from the electrical energy store and the fuel cell stack to provide DC power to the E-Machine interface subsystem.

According to another aspect of the invention a power management system is provided. The power management system is for supplying power to one or more motors for driving a fuel cell electric vehicle. The power management system comprises a high voltage power management module as described herein or a DC-DC converter as described herein. The power management system further comprises an electrical energy store as described herein. The power management system further comprises a vehicle control unit as described herein.

According to another aspect of the invention a fuel cell electric vehicle is provided. The fuel cell electric vehicle comprises a power management system as described herein. The fuel cell electric vehicle further comprises a fuel cell stack coupled to the high voltage power management module or DC-DC converter, the high voltage power management module or DC-DC converter to provide DC power from the fuel cell stack to drive the one or more motors of the vehicle for driving a drivetrain of the vehicle.

In examples of the present disclosure, the switching module may be further configured to be operable to provide DC power from the fuel cell interface subsystem to the storage interface subsystem to charge the electrical energy store.

In examples of the present disclosure, the switching module may be further configured to be operable to provide DC power recovered from the from the E-Machine interface subsystem to the storage interface subsystem to charge the electrical energy store.

In examples of the present disclosure, the electrical energy store may be sized such that the total energy providable to the one or more motors for driving the fuel cell electric vehicle by discharging the electrical energy store from its maximum charge capacity to depletion is an order of magnitude less than the total energy providable by the fuel cell stack from a fuel store in the vehicle in normal use.

In examples of the present disclosure, the peak deployable output power from the electrical energy store may be greater than the peak deployable output power from the fuel cell stack, optionally at least 1.25 times greater, optionally at least 1.5 times greater, optionally at least 1.75 times greater, optionally at least 2.00 times greater.

In examples of the present disclosure, the electrical energy store may be configured to have a maximum voltage of at least 700V.

In examples of the present disclosure, the weight of the electrical energy store may be less than 15% of the kerb weight of the fuel cell electric vehicle.

In examples of the present disclosure, the fuel cell stack may be sized such that the peak deployable output power of the fuel cell stack is sufficient to solely drive the one or more motors of the vehicle for driving the drivetrain of the vehicle in intended normal driving operation for the vehicle without relying on output power from the electrical energy store, wherein optionally the output of the fuel cell stack may be at least 75 KW, optionally at least 100 KW, optionally at least 125 KW, optionally at least 150 KW.

In examples of the present disclosure, the fuel cell stack may be divided into multiple separately operable fuel cell sub-stacks. The VCU, high voltage power management module described herein or DC-DC converter described herein may be configured to cause the sub-stacks to be activated in order to provide required DC power to drive the drivetrain of the vehicle based on the requested torque signal.

In examples of the present disclosure, the control module may be configured to provide at the output control signals for the high voltage power management module described herein or DC-DC converter described herein indicating whether to select or combine a source of power from the electrical energy store and the fuel cell stack to provide DC power to the E-Machine interface subsystem.

In examples of the present disclosure, the control module may be configured to generate a control signal for outputting to the high voltage power management module described herein or DC-DC converter described herein based on the requested torque signal. The control signal may configure the high voltage power management module or DC-DC converter, fuel cell stack and electrical energy store to operate in a mode selected from a group comprising one or more of:
a steady state mode in which DC power is provided directly by the fuel cell stack to drive the one or more motors for driving a drivetrain of the vehicle to optimise the power management system for a scenario in which the requested torque and the power to be deployed to the motors are in a steady state, optionally in which no DC power is simultaneously provided by the electrical energy store;
a transient mode in which DC power is provided directly by the electrical energy store to drive the one or more motors for driving a drivetrain of the vehicle to optimise the power management system for a scenario in which the requested torque and the power to be deployed to the motors are in a transient state, optionally in which DC power is simultaneously provided by the fuel cell stack to the electrical energy store to charge the electrical energy store; and
a high output mode in which DC power is provided simultaneously by both the electrical energy store and the fuel cell stack to drive the one or more motors for driving a drivetrain of the vehicle to optimise the power management system for a scenario in which the requested torque and the power to be deployed to the motors require a power deployment beyond the peak energy output of the electrical energy store and the fuel cell stack individually.

According to another aspect of the invention a method is provided. The method is of managing the supply of power to one or more motors for driving a fuel cell electric vehicle described herein. The method comprises, when the requested torque signal and the power to be deployed to the motors are in a steady state, signalling to a vehicle control unit of the power management system to operate in a steady state mode in which DC power is provided directly by the fuel cell stack to drive the one or more motors for driving a drivetrain of the vehicle. The method further comprises, when the requested torque signal and the power to be deployed to the motors are in a transient state, signalling to a vehicle control unit of the power management system to operate in a transient mode in which DC power is provided directly by the electrical energy store to drive the one or more motors for driving a drivetrain of the vehicle. The method further comprises, when the requested torque signal and the power to be deployed to the motors require a power deployment beyond the peak energy output of the electrical energy store and the fuel cell stack individually, signalling to a vehicle control unit of the power management system to operate in a high output mode in which DC power is provided simultaneously by both the electrical energy store and the fuel cell stack to drive the one or more motors for driving a drivetrain of the vehicle.

In examples of the present disclosure, in the signalled steady state mode, the power management system may simultaneously draw no DC power from the electrical energy store to supply power to one or more motors.

In examples of the present disclosure, in the signalled transient mode, the power management system may simultaneously provide DC power from the fuel cell stack to the electrical energy store to charge the electrical energy store.

According to another aspect of the invention a computer programme product is provided. The computer programme product carries instructions for configuring a vehicle control unit as described herein to operate the methods as described herein in a fuel cell electric vehicle as described herein.

It will be appreciated from the foregoing disclosure and the following detailed description of the examples that certain features and implementations described as being optional in relation to any given aspect of the disclosure set out above should be understood by the reader as being disclosed also in combination with the other aspects of the present disclosure, where applicable. Similarly, it will be appreciated that any attendant advantages described in relation to any given aspect of the disclosure set out above should be understood by the reader as being disclosed as advantages of the other aspects of the present disclosure, where applicable. That is, the description of optional features and advantages in relation to a specific aspect of the disclosure above is not limiting, and it should be understood that the disclosures of these optional features and advantages are intended to relate to all aspects of the disclosure in combination, where such combination is applicable.

### BRIEF DESCRIPTION OF THE DRAWINGS

Embodiments of the invention are further described hereinafter, by way of example only, with reference to the accompanying drawings, in which:

FIG. 1 shows a high voltage power management module in accordance with an example of the present disclosure;

FIG. 2 shows a power management system in accordance with an example of the present disclosure;

FIG. 3 shows a fuel cell electric vehicle in accordance with an example of the present disclosure;

FIG. 4 shows a method of managing the supply of power to one or more motors for driving a fuel cell electric vehicle in accordance with an example of the present disclosure; and

FIG. 5 shows a computer programme product in accordance with an example of the present disclosure.

Throughout the description and drawings, like reference numerals refer to like parts.

### DETAILED DESCRIPTION

Hereinafter, embodiments of the disclosure are described with reference to the accompanying drawings. However, it should be appreciated that the disclosure is not limited to the embodiments, and all changes and/or equivalents or replacements thereto also belong to the scope of the disclosure. The same or similar reference denotations may be used to refer to the same or similar elements throughout the specification and the drawings.

As used herein, the terms “have,” “may have,” “include,” or “may include” a feature (e.g., a number, function, operation, or a component such as a part) indicate the existence of the feature and do not exclude the existence of other features.

As used herein, the terms “A or B,” “at least one of A and/or B,” or “one or more of A and/or B” may include all possible combinations of A and B. For example, “A or B,” “at least one of A and B,” “at least one of A or B” may indicate all of (1) including at least one A, (2) including at least one B, or (3) including at least one A and at least one B.

As used herein, the terms “configured (or set) to” may be interchangeably used with the terms “suitable for,” “having the capacity to,” “designed to,” “adapted to,” “made to,” or “capable of” depending on circumstances. The term “configured (or set) to” does not essentially mean “specifically designed in hardware to.” Rather, the term “configured to” may mean that a device can perform an operation together with another device or parts.

For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

The terms as used herein are provided merely to describe some embodiments thereof, but not to limit the scope of other embodiments of the disclosure. It is to be understood that the singular forms “a,” “an,” and “the” include plural references unless the context clearly dictates otherwise. All terms including technical and scientific terms used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the disclosure.

Throughout the figures, whilst arrows are used to indicate the typical direction that signals are sent, signals may also be sent in the opposite direction. Thus, where arrows are used to aid in explanation, they do not limit to one way communication, but include two-way communication.

As will be appreciated upon reading the detailed description, a vehicle is any movable machine that has motors used to move the machine. For example, a vehicle may be a train, a car or a lorry. A drivetrain of a vehicle is the vehicle itself, where the vehicle cannot be split into parts, or a part of a vehicle, where the vehicle can be split into parts. For example, a drivetrain of a train is a carriage of a train. A drivetrain of a car is the car. The vehicle comprises one or more motors. Driving motors of a vehicle drives the vehicle.

As will be appreciated upon reading the detailed description, a fuel cell electric vehicle is a vehicle that uses electricity to power the motors, and that comprises a fuel cell. A fuel cell electric vehicle comprises an electric machine (E-Machine) which converts electrical power to mechanical power. The E-Machine drives the one or motors to drive the vehicle.

As will be appreciated upon reading the detailed description, high voltage may be any voltage at or above 48V.

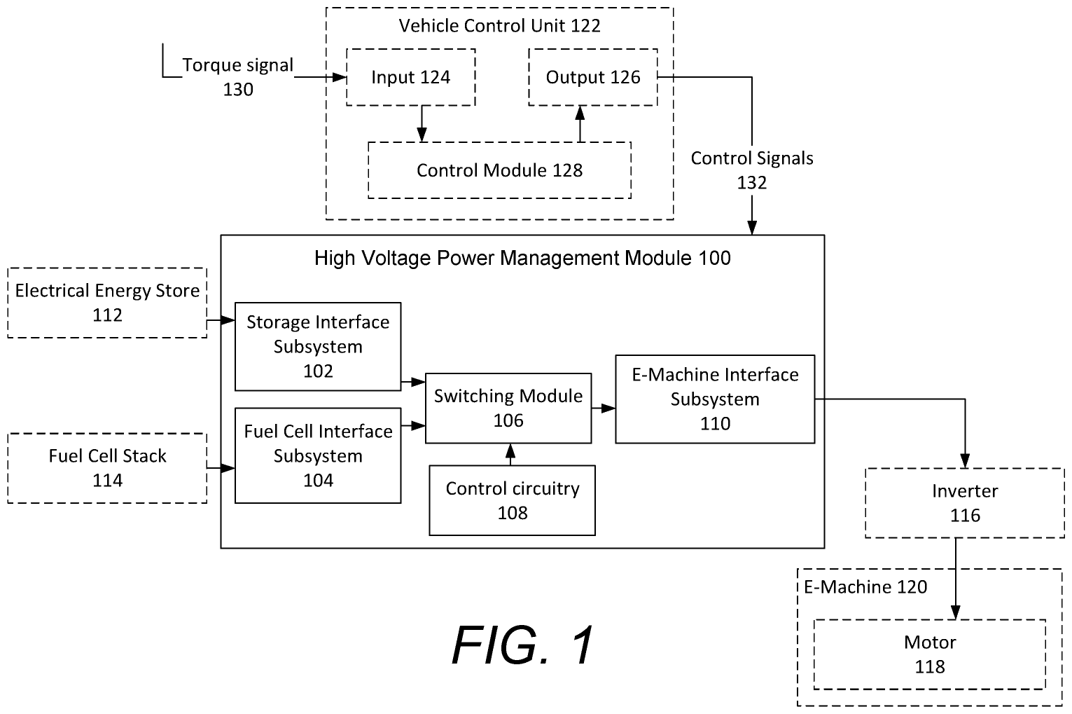

FIG. 1 shows a high voltage power management module 100 in accordance with an example of the present disclosure. Components in communication with the high voltage power management module 100 are also shown in FIG. 1, and are illustrated in dashed lines, showing they are optional.

The high voltage power management module is for supplying power to one or more motors 118 for driving a fuel cell electric vehicle. The high voltage power management module 100 comprises an E-Machine interface subsystem 110 for exchanging DC power with an inverter 116 configured to provide AC power to one or more motors 118 for driving a drivetrain of the vehicle. The high voltage power management module 100 further comprises a storage interface subsystem 102 to exchange DC power with an electrical energy store 112 for providing transient power to drive the fuel cell electric vehicle. The high voltage power management module 100 further comprises a fuel cell interface subsystem 104 for receiving DC power from a fuel cell stack 114 of the vehicle configured to directly drive the one or more motors 118 through the E-Machine interface subsystem 110 of the high voltage power management module. The high voltage power management module 100 further comprises a switching module 106 configured to direct the voltage between the DC power of the storage interface subsystem 102, the fuel cell interface subsystem 104 and the E-Machine interface subsystem 110, wherein the switching module 106 is configured to be operable to rapidly switch between or simultaneously combine DC power from the storage interface subsystem 102 and the fuel cell interface subsystem 104 to provide DC power to the E-Machine interface subsystem 110 to drive the one or more motors 118 for driving a drivetrain of the vehicle. The high voltage power management module 100 further comprises control circuitry 108 coupled to the switching module 106 to control the switching module 106 to select or combine a source of DC power from the electrical energy store 112 and the fuel cell stack 114 to provide DC power to the E-Machine interface subsystem 110.

When the DC power from the storage interface subsystem 102 and the fuel cell interface subsystem 104 is combined, this significantly increases vehicle performance. For example, the vehicle performance may be double that of conventional fuel cell vehicles. For example, the amount of power that is supplied to the motors 118 to drive the motors 118 is significantly more than for conventional fuel cell vehicles.

The high voltage power management module 100 may be connected or connectable to one or more of the electrical energy store 112, fuel cell stack 114, vehicle control unit 122 and inverter 116.

The high voltage power management module 100 manages the power supplied by an electrical energy store 112 and a fuel cell stack 114 in order to deliver appropriate power to one or more motors 118 of a vehicle. Power may be delivered to the one or motors 118 for driving a drivetrain of the vehicle. Whilst one motor 118 is illustrated in FIG. 1, any number of motors may be supplied with power by the high voltage power management module 100. The high voltage power management module 100 may supply power equally to each motor 118, for example by splitting the power equally before supplying the power to each motor. In another example, the power supplied to the motors may be divided based on the vehicle type and vehicle movement.

The E-Machine interface subsystem 110 may interface with the E-Machine 120. The E-Machine 120 may comprise the one or more motors 118. The E-Machine interface subsystem 110 may output power from the high voltage power management module 100. The E-Machine interface subsystem 110 may send power to the motors 118 of the E-Machine 120 to drive the motors in order to move the vehicle. The E-Machine interface subsystem 110 may be connected to the motors 118 via an inverter 116. The voltage supplied to the inverter 116 may be DC. The inverter 116 may convert the DC power output by the E-Machine interface subsystem 110 into AC power and provide the AC power to the motors 118. AC power may be required to drive the motors 118. The inverter 116 may form part of the E-Machine 120 or the high voltage power management module 100. The E-Machine interface subsystem 110 may also receive power from the motors 118. In an example, the E-Machine interface subsystem 110 may receive regenerative energy from the motors, for example, power generated from the braking of the vehicle.

The storage interface subsystem 102 may interface with an electrical energy store 112. The storage interface subsystem 102 may receive power from the electrical energy store 112 when the electrical energy store 112 is connected to the high voltage power management module 100. The power received from the electrical energy store 112 may be output by the E-Machine interface subsystem 110 to the motors 118 of the E-Machine 120 to drive the motors 118. In some examples, with the exception of any loss caused by power transfer and inversion, all power received from the electrical energy store 112 may be used to power the motors 118 of the E-Machine 120.

The storage interface subsystem 102 may also transmit power to the electrical energy store 112. For example, the storage interface subsystem 102 may receive power input into the high voltage power management module 100 and originating from the fuel cell stack 114 or the motor 118 and send the power to the electrical energy store 112 in order to store the power for future use. In an example, where the power received from the fuel cell stack 114 exceeds the power required by the E-Machine 120, the power received from the fuel cell stack 114 may be stored in the electrical energy store 112.

The electrical energy store 112 is for use with the high voltage power management module 100. The electrical energy store 112 is for supplying power to one or more motors 118 for driving a fuel cell electric vehicle. The electrical energy store 112 may be any means of storing electrical energy. The electrical energy store 112 may be rechargeable. The electrical energy store 112 may be an electrical battery, such as a lithium based battery. In one example, the electrical energy store 112 may be a secondary cell. In another example, the electrical energy store 112 may be flywheel energy storage, which stores electrical energy in the form of kinetic energy. In another example, the electrical energy store 112 may be an ultracapacitor. In another example, the electrical energy store 112 may be a light weight lithium based battery which provides very high energy outputs from small energy capacities. Thus, the storage interface subsystem 102 may interface with any means of storing electrical energy.

The electrical energy store 112 may be configured to have a maximum charge capacity, and a peak deployable output power such that, when operating at peak deployable output, the electrical energy store 112 is discharged from its maximum charge capacity to depletion in less than 7 minutes. The electrical energy store 112 may be configured to have a maximum charge capacity, and a peak deployable output power such that, when operating at peak deployable output, the electrical energy store 112 is discharged from its maximum charge capacity to depletion in less than 5 minutes or less than 4 minutes. The electrical energy store 112 may be configured to have a maximum charge capacity, and a peak deployable output power such that, when operating at peak deployable output, the electrical energy store 112 is discharged from its maximum charge capacity to depletion in less than 3 minutes or less than 2 minutes. In an example, the electrical energy store 112 may be configured to have a maximum charge capacity, and a peak deployable output power such that, when operating at peak deployable output, the electrical energy store 112 is discharged from its maximum charge capacity to depletion in approximately 120 seconds. The electrical energy store 112 may have an energy capacity of less than 10 kWh. The electrical energy store 112 may have an energy capacity of 8 kWh. The electrical energy store 112 may weigh less than 100 kg. The electrical energy store 112 may have a 300 KW peak output. The electrical energy store 112 may be configured to have a maximum voltage of at least 700V. The weight of the electrical energy store 112 may be less than 15% of the kerb weight of the fuel cell electric vehicle.

The electrical energy store 112 may be sized such that the total energy providable to the one or more motors 118 for driving the fuel cell electric vehicle by discharging the electrical energy store from its maximum charge capacity to depletion is an order of magnitude less than the total energy providable by the fuel cell stack 114 from a fuel store in the vehicle in normal use.

The peak deployable output power from the electrical energy store 112 may be greater than the peak deployable output power from the fuel cell stack 114. For example, the peak deployable output power from the electrical energy store 112 may be at least 1.25 times greater than the peak deployable output power from the fuel cell stack 114. For example, the peak deployable output power from the electrical energy store 112 may be at least 1.5 times greater than the peak deployable output power from the fuel cell stack 114. For example, the peak deployable output power from the electrical energy store 112 may be at least 1.75 times greater than the peak deployable output power from the fuel cell stack 114. For example, the peak deployable output power from the electrical energy store 112 may be at least 2.00 times greater than the peak deployable output power from the fuel cell stack 114.

The electrical energy store 112 may have a high discharge capability. For example, the electrical energy store 112 may have a discharge rate of between 50 and 75 C, where C is the capacity of the electrical energy store 112. The electrical energy store 112 may have a high charge rate, for example, of between 30 and 50 C. The electrical energy store 112 may be split into modules. For example, the electrical energy store 112 may comprise a top and bottom module. One or both modules may be actively cooled. The electrical energy store 112 may comprise, or may be coupled to, a battery management system configured to support very high charge and discharge rates and ensure the safety of the battery cells during high rate charge and discharge.

An example electrical energy store 112 is a lithium battery that has an energy capacity of 8 kWh, a maximum voltage of 777 Volts, a maximum output of 300 KW and a weight of 135 KG.

Whilst one electrical energy store 112 is illustrated in FIG. 1, any number of electrical energy stores 112 may be connected or connectable to the high voltage power management module 100. In an example, the electrical energy store 112 may comprise a plurality of secondary cells. Each cell may be individually connectable to the high voltage power management module. The high voltage power management module 100 may comprise a plurality of storage interface subsystems 102 to connect to each of the plurality of electrical energy stores 112 or plurality of secondary cells. Alternatively the plurality of electrical energy stores 112 or plurality of secondary cells may be connected or connectable to one storage interface subsystem 102.

The electrical energy store 112 reduces lithium use, boosts efficiency due to its low weight and is optimized for multi hundred KW per minute outputs creating the perfect energy store for fuel cell vehicles.

The fuel cell interface subsystem 104 may interface with a fuel cell stack 114. The fuel cell interface subsystem 104 may receive power from the fuel cell stack 114 when the fuel cell stack 114 is connected to the high voltage power management module 100. The power received from the fuel cell stack 114 may be output by the E-Machine interface subsystem 110 to the motors 118 of the E-Machine 120 to drive the motors 118. The power received from the fuel cell stack 114 may directly drive the one or more motors 118. That is, the power received from the fuel cell stack 114 may not be stored in the electrical energy store 112 before driving the one or more motors 118. As soon as the power is received from the fuel cell stack 114, it may be output by the E-Machine interface 110 to the inverter 116 and, once converted to AC, to the motor 118. The power received from the fuel cell stack 114 may additionally or alternatively be output by the storage interface subsystem 102 to be stored in the electrical energy store 112.

As the fuel cell stack 114 may directly drive the motors 118, the electrical energy store 112 does not need to discharge as often, and so the number of significant battery discharge cycles during operation is reduced. This increases the lithium based energy store life of the electrical energy store 112 by up to 50% compared with conventional lithium battery electric vehicles. Moreover, the significant reduction in lithium battery usage reduces the cost of the electrical energy store 112, the power management system comprising the electrical energy store 112 and the fuel cell electric vehicle comprising the electrical energy store 112.

The fuel cell stack 114 may comprise one or more fuel cells. Each fuel cell may be a hydrogen fuel cell. Each fuel cell may be for generating electricity by consuming the hydrogen, the electricity then sent to the fuel cell interface subsystem 104. Fuel cells can continue in their operation for as long as there is a supply of hydrogen from a source, which is typically stored under pressure as a liquid or gas in a hydrogen storage tank. The fuel cell stack may comprise or may be connected or connectable to a hydrogen storage tank. One or more fuel cells of the fuel cell stack 114 can be activated to provide power to the switching module 106. Moreover, where there are a plurality of fuel cell stacks connected to the high voltage power management module 100, one or more of the fuel cell stacks 114 can be activated to provide power to the switching module 106.

The fuel cell stack 114 may be sized such that the peak deployable output power of the fuel cell stack is sufficient to solely drive the one or more motors 118 of the vehicle for driving the drivetrain of the vehicle in intended normal driving operation for the vehicle without relying on output power from the electrical energy store. The output of the fuel cell stack may be at least 75 KW. The output of the fuel cell stack may be at least 100 KW. The output of the fuel cell stack may be at least 125 KW. The output of the fuel cell stack may be at least 150 KW.

The fuel cell stack 114 may be divided into multiple separately operable fuel cell sub-stacks. The VCU, high voltage power management module described herein or DC-DC converter described herein may be configured to cause These sub-stacks may be activated, for example by the VCU 112 or high voltage power management module 100, in order to provide required DC power to drive the drivetrain of the vehicle based on the requested torque signal.

The fuel cell stack 114 and/or fuel cell sub-stack may comprise a plurality of fuel cells. Moreover, whilst one fuel cell stack 114 is illustrated in FIG. 1, there may be a plurality of fuel cell stacks 114 connected or connectable to the high voltage power management module 100. The high voltage power management module 100 may comprise a plurality of fuel cell interface subsystems 104 to connect to each of the plurality of fuel cell stacks 114. Alternatively the plurality of fuel cell stacks 114 may be connected or connectable to one fuel cell interface subsystem 104.

The switching module 106 may direct where the power received by the high voltage power management module 100 is sent. Thus, the switching module, or the high voltage power management module as a whole, may act as a DC bus. Thus, the switching module 106, acting as a DC bus, may have a required DC bus system voltage. The high voltage power management module 100 may receive power from the electrical energy store 112 via the storage interface subsystem 102, from the fuel cell stack 114 via the fuel cell interface subsystem 104 and/or from the motor 118 via the E-Machine interface subsystem 110. The switching module may direct this received power to the electrical energy store 112 via the storage interface subsystem 102 and/or to the motor 118 via the E-Machine interface subsystem 110. The switching module may be any means of directing power.

The switching module 106 may be controllable to receive the power received by the high voltage power management module 100. That is, the switching module 106 may be controllable to receive power from one or more of the electrical energy store 112 via the storage interface subsystem 102, the fuel cell stack 114 via the fuel cell interface subsystem 104 and/or the motor 118 via the E-Machine interface subsystem 110. The switching module 106 may be controllable to transmit power to one or more of the electrical energy store 112 via the storage interface subsystem 102 and the motor 118 via the E-Machine interface subsystem 110.

The control of the switching module, and so whether the power provided to the motor 118 is from the electrical energy store 112 and/or the fuel cell stack 114 is based on the way the vehicle is being driven. This is because the electrical energy store 112 and the fuel cell stack 114 have different characteristics. The fuel cell stack 114 provides a consistent output power and so is useful when the power required by the vehicle to drive the vehicle remains constant, or in a steady state. The electrical energy store 112 provides bursts of energy and has a high peak deployable output, but cannot provide energy for a long time without requiring recharging. Therefore the electrical energy store 112 is useful when there are large transients in power required by the vehicle to drive the vehicle. The electrical energy store 112 is also useful to combine with the fuel cell stack 114 when a high power is required by the vehicle to drive the vehicle. The control of the switching module may be based on the operational mode of the fuel cell stack 114, electrical energy store 112 and high voltage power management module 100, which is described in detail below.

The switching module 106 may be capable of withstanding high power. The switching module may be a high power switch. The switching module 106 may be a mechanical switch. The switching module 106 may be a solid state switch.

Where there are a plurality of electrical energy stores 112 and/or a plurality of fuel cell stacks 114, the switching module may exchange power with each of the plurality of electrical energy stores 112 via one or more storage interface subsystems 102 and/or each of the plurality of fuel cell stacks 114 via one or more fuel cell interface subsystems 104. Thus, any number of fuel cell stacks 114 and electrical energy stores 112 can be connected to the high voltage power management module 100 to provide a flexible amount of power to the switching module 106 and to the motors 118. For example, where a high power is required, additional fuel cell stacks 114 and/or electrical energy stores 112 can be connected to the high voltage power management module 100. For example, where a fuel cell stack 114 provides 75 KW of power, two fuel cell stacks 114 may be used in order to generate a power output of 150 KW. The flexibility in the number of fuel cell stacks 114 allows better optimisation of fuel cell generated power use for best efficiency and lowest possible hydrogen consumption.

In some examples, the switching module 106 may receive power from the electrical energy store 112 via the storage interface subsystem 102 or from the fuel cell stack 114 via the fuel cell interface subsystem 104 and direct the received power to the motor 118 via the E-Machine interface subsystem 110. The switching module may receive power from both the storage interface subsystem 102 and the fuel cell interface subsystem 104 and may combine the power and direct the combined power to the E-Machine interface subsystem 110. Thus, the switching module may rapidly switch between or simultaneously combine the power received from the storage interface subsystem 102 and the fuel cell interface subsystem 104 to provide power to the E-Machine interface subsystem 110 to drive the one or more motors 118.

The switching module may be controlled by control circuitry 108 coupled to the switching module 106. The control circuitry 108 may control whether the switching module is to direct power from one or both the storage interface subsystem 102 and the fuel cell interface subsystem 104 to the E-Machine interface subsystem 110. Consequently, the control circuitry 108 may control the switching module to rapidly switch between or simultaneously combine the power received from the storage interface subsystem 102 and the fuel cell interface subsystem 104 to provide DC power to the E-Machine interface subsystem 110.

The switching module 106 may, additionally or alternatively, direct the power received from the fuel cell 114 via the fuel cell interface subsystem 104 to the storage interface subsystem 102 to charge the electrical energy store 112. The power from the fuel cell 114 can then be stored in the electrical energy store 112 for future use. The switching module 106 may, additionally or alternatively, provide DC power recovered from the from the E-Machine interface subsystem 110 to the storage interface subsystem 102 to charge the electrical energy store 112. The power recovered from the E-Machine interface subsystem 110 can then be stored in the electrical energy store 112 for future use. Power recovered from the E-Machine interface subsystem may be regenerative energy produced by the motor 118.

Whilst the storage interface subsystem 102, fuel cell interface subsystem 104, switching module 106, control circuitry 108 and E-Machine interface subsystem 110 are distinguished in FIG. 1, this is for illustrative purposes, and in order to explain the operation of the high voltage power management module. Any number of these subsystems may be combined in a single hardware component. In an example, a single hardware component may comprise the storage interface subsystem 102, fuel cell interface subsystem 104, switching module 106, control circuitry 108 and E-Machine interface subsystem 110, as it may perform the operation of all these subsystems.

The high voltage power management module 100 may manage DC power supplied by an electrical energy store 112 and a fuel cell stack 114 in order to deliver appropriate power to one or more motors 118 of a vehicle. All power within the high voltage power management module 100 may be DC power.

The high voltage power management module 100 may be connected to a DC-DC converter. For example, the high voltage power management module 100 may be connected to the fuel cell stack 114 via a DC-DC converter (not shown). The fuel cell interface subsystem 104 may receive power from the fuel cell stack 114 via the DC-DC converter. The fuel cell stack 114 may be coupled to the DC-DC converter. Power output from the fuel cell stack 104 may be variable and of a lower voltage and higher current than that required to power a motor and drive a vehicle. The DC-DC converter may be used to stabilise and step up the power output from the fuel cell stack 104 to provide a converted power to the fuel cell interface subsystem 104. For example, the DC-DC converter may step the power received from the fuel cell stack 114 up to a high voltage required by the high voltage power management module 100, for example the DC bus system voltage mentioned above.

Additionally or alternatively, the high voltage power management module 100 may be a DC-DC converter. The DC-DC converter may receive the power output from the fuel cell stack 104 and convert the power to a DC by stabilising the power and/or stepping the power up to a high voltage required by the DC-DC converter, for example the DC bus system voltage mentioned above.

The DC-DC converter may step the voltage up such that the power provided to the motor 118 is of a higher DC voltage level than the power provided by the storage interface subsystem 102 and/or the fuel cell interface subsystem 104. Throughout the specification, where a high voltage power management module 100 is described, this may be a DC-DC converter.

When the high voltage power management module 100 is a DC-DC converter, the switching module 106 is further configured to step the voltage between the DC power of the storage interface subsystem 102, the fuel cell interface subsystem 104 and the E-Machine interface subsystem 110. The switching module 106 is further configured to be operable to rapidly switch between or simultaneously combine DC power from the storage interface subsystem 102 and the fuel cell interface subsystem 104 to provide converted DC power to the E-Machine interface subsystem 110 to drive the one or more motors for driving a drivetrain of the vehicle. The control circuitry 108 is further configured to control the switching module 106 to select or combine a source of DC power from the electrical energy store 112 and the fuel cell stack 114 to provide converted DC power to the E-Machine interface subsystem 110.

Thus, in addition to rapidly switching between or simultaneously combining the power received from the storage interface subsystem 102 and the fuel cell interface subsystem 104 to provide power to the E-Machine interface subsystem 110 to drive the one or more motors 118, the switching module 106 may also perform DC-DC conversion on the power received from the storage interface subsystem 102 and/or the fuel cell interface subsystem 104 to step the voltage such that the power provided to the E-Machine interface subsystem 110 is converted DC power. Thus, the switching module 106 may effectively be a power converter. The switching module 106 may step the voltage up such that the power provided to the E-Machine interface subsystem 110 is of a higher DC voltage level than the power received by the switching module 106 from the storage interface subsystem 102 and/or the fuel cell interface subsystem 104.

The high voltage power management module 100 may be connectable or connected to a vehicle control unit, VCU, 122. The VCU 122 is for use with the high voltage power management module 100. The VCU 122 has an input 124 to receive a torque signal 130 indicative of a requested torque to be provided to a drivetrain of the vehicle. The VCU 122 has an output 126 to provide control signals 132 to the high voltage power management module 100. The VCU 122 has a control module 128 configured to provide at the output 126 control signals for the high voltage power management module or DC-DC converter indicating whether to select or combine a source of power from the electrical energy store 112 and the fuel cell stack 114 to provide DC power to the E-Machine interface subsystem 110.

The torque signal 130 may be provided to the VCU 122 by, for example, a driver of the vehicle or from the vehicle itself. The torque signal 130 may indicate the torque to be provided to the vehicle, as requested by, for example, the driver. The VCU 122 may also receive signals from the electrical energy store 112 and/or fuel cell stack 114 for monitoring purposes. For example, the VCU 122 may receive a signal from the electrical energy store 112 indicating the state of charge of the electrical energy store 112. In an example, where hydrogen storage forms part of the fuel cell stack, the VCU 122 may receive a signal from the fuel cell stack 114 indicating the amount of hydrogen in the hydrogen storage. The control signals 132 may be based on the signals received from the electrical energy store 112 and/or fuel cell stack 114.

The control module 128 may receive the torque signal 130 inputted into the VCU 122 and may determine, based on the torque signal 130, whether to select or combine a source of power from the electrical energy store 112 and the fuel cell stack 114 to provide DC power to the E-Machine interface subsystem 110. In some examples, a small amount of torque may be requested, for example, when the vehicle is in slow moving traffic. The torque signal 130 may indicate that a small amount of torque is requested. The control module 112 may determine, based on the torque signal 130, that the most efficient way to meet this torque demand is via the electrical energy store 112 and so may determine to select the electrical energy store 112 as the source of power for the motors 118. The control module 112 may also monitor the state of charge of the electrical energy store 112 and may determine to transfer power from the fuel cell stack 114 to the electrical energy store 112 when necessary. In some examples, a large torque may be requested, for example, when the vehicle is joining a motorway via an uphill slip road. The torque signal 130 may indicate that a large amount of torque is requested. The control module 112 may determine, based on the torque signal 130, that maximum power is required and so may determine to combine the power from the electrical energy store 112 and the fuel cell stack 114 to provide maximum power to the inverter 116.

The control module 128 may output its determination using the control signals 132 to the high voltage power management module 100. The control signals 132 may therefore be based on a requested torque to be provided to a drivetrain of the vehicle. The control signals may be sent to the control circuitry 108 of the high voltage power management module 100. The control signals 132 may indicate whether to select or combine a source of power from the electrical energy store 112 and the fuel cell stack 114 to provide DC power to the E-Machine interface subsystem. The control circuitry 108 may control whether the switching module is to direct power from one or both the storage interface subsystem 102 and the fuel cell interface subsystem 104 to the E-Machine interface subsystem 110 based on the control signals 132.

The control circuitry 108 may also control whether the switching module is to direct power from the fuel cell interface subsystem 104 or the E-Machine interface subsystem 110 to the storage interface subsystem 102 based on the control signals 132.

Where the switching module 106 receives power from and directs power to may be determined based on the mode of operation of the high voltage power management module 100, fuel cell stack 114 and electrical energy store 112, as determined by the control module 128 of the vehicle control unit 122. The control signals 128 generated by the control module 128 may configure the high voltage power management module 100, fuel cell stack 114 and electrical energy store 112 to operate in a particular mode. The mode may be a steady state mode, a transient mode or a high output mode. Other modes are also envisioned.

For a scenario in which the requested torque and the power to be deployed to the motors 118 are in a steady state, the control signal may configure the high voltage power management module 100, fuel cell stack 114 and electrical energy store 112 to operate in a steady state mode in order to optimise the use of the fuel cell stack 114 and electrical energy store 112. In the steady state mode, DC power is provided directly by the fuel cell stack 114 to drive the one or more motors 118 for driving a drivetrain of the vehicle. In this mode, there may be no DC power simultaneously provided by the electrical energy store 112. The provision of DC power directly from the fuel cell stack 114 reduces losses from storing energy in the energy store and immediately redeploying it. Steady state mode may also be known as high efficiency mode. An example scenario for steady state mode operation is driving on a highway.

For a scenario in which the requested torque and the power to be deployed to the motors 118 are in a transient state, the control signal may configure the high voltage power management module 100, fuel cell stack 114 and electrical energy store 112 to operate in a transient mode in order to optimise the use of the fuel cell stack 114 and electrical energy store 112. In the transient mode, DC power is provided directly by the electrical energy store 112 to drive the one or more motors 118 for driving a drivetrain of the vehicle. In this mode, DC power may be simultaneously provided by the fuel cell stack 114 to the electrical energy store 112 to charge the electrical energy store 112. The fuel cell stack 114 may therefore be used to maintain the required energy store state of charge. An example scenario for transient mode operation is one that requires large transients in energy deployment, for example, city driving.

For a scenario in which the requested torque and the power to be deployed to the motors 118 require a power deployment beyond the peak energy output of the electrical energy store and the fuel cell stack individually, the control signal may configure the high voltage power management module 100, fuel cell stack 114 and electrical energy store 112 to operate in a high output mode in order to optimise the use of the fuel cell stack 114 and electrical energy store 112. In the high output mode, DC power is provided simultaneously by both the electrical energy store 112 and the fuel cell stack 114 to drive the one or more motors for driving a drivetrain of the vehicle. The provision of the combination of power from the electrical energy store 112 and the fuel cell stack 114 provide maximum output for maximum vehicle performance. An example scenario for high output mode operation is one that requires maximum vehicle performance, such as overtaking or hill climbing.

As the switching module 106 rapidly switches, the mode of operation can be switched extremely quickly within the vehicle depending on the current scenario and/or driver torque request, allowing multi-mode per second operation.

By allowing multiple modes of operation, the use of the electrical energy store 112 and fuel cell stack 114 is optimised and the hydrogen consumption by the fuel cell stack 114 is reduced. Moreover the vehicle efficiency and performance are increased.

Whilst the VCU is shown as being connected to the high voltage power management module 100, the VCU may, alternatively or additionally, be connectable or connected to other modules.

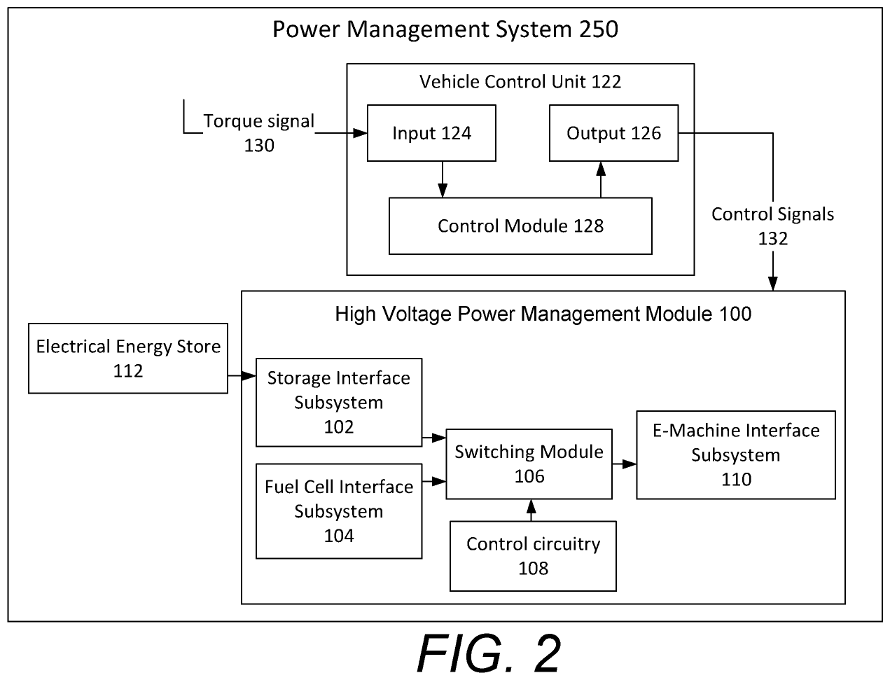

The high voltage power management module 100, VCU 122 and electrical energy store 112 may form a power management system 250. FIG. 2 shows a power management system 250 in accordance with an example of the present disclosure. The power management system 250 is for supplying power to one or more motors for driving a fuel cell electric vehicle. The power management system 250 comprises a high voltage power management module 100, an electrical energy store 112 and a vehicle control unit 122. The high voltage power management module 100, electrical energy store 112 and vehicle control unit 122 have been described in FIG. 1.

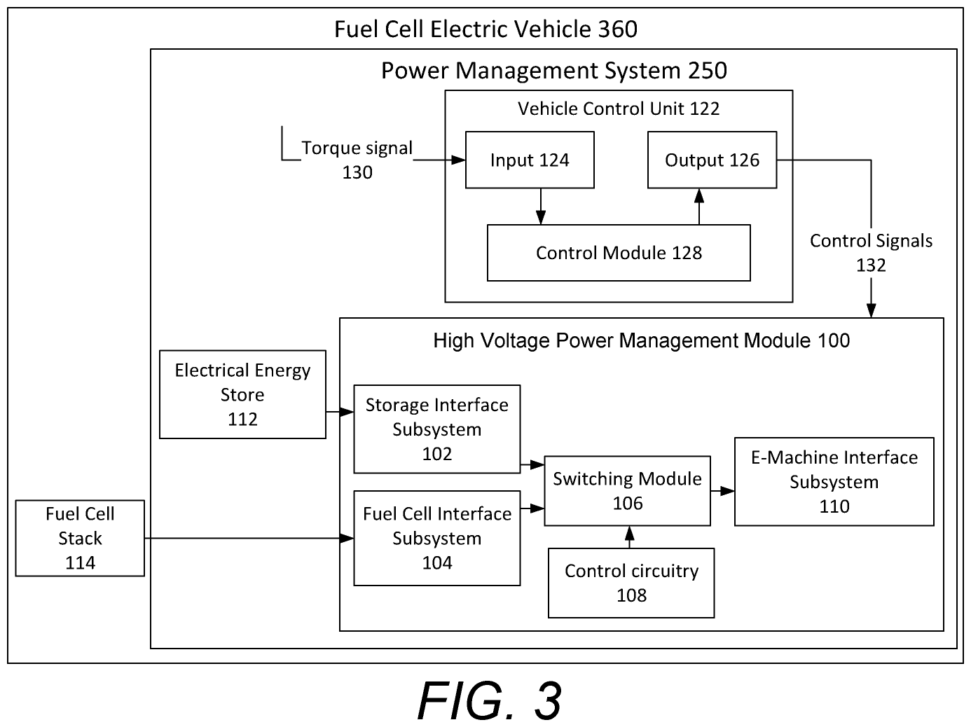

The power management system 250 of FIG. 2 may be combined with a fuel cell stack 114 of FIG. 1 to form a Fuel Cell Electric Vehicle 360. FIG. 3 shows a fuel cell electric vehicle 360 in accordance with an example of the present disclosure. The fuel cell electric vehicle 360 comprises a power management system 250 and a fuel cell stack 114 coupled to the high voltage power management module 100 of the power management system 250, the high voltage power management module 100 to provide DC power from the fuel cell stack 114 to drive the one or more motors of the vehicle for driving a drivetrain of the vehicle. The power management system 250 has been described in FIG. 2 and the fuel cell stack 114 has been described in FIG. 1.

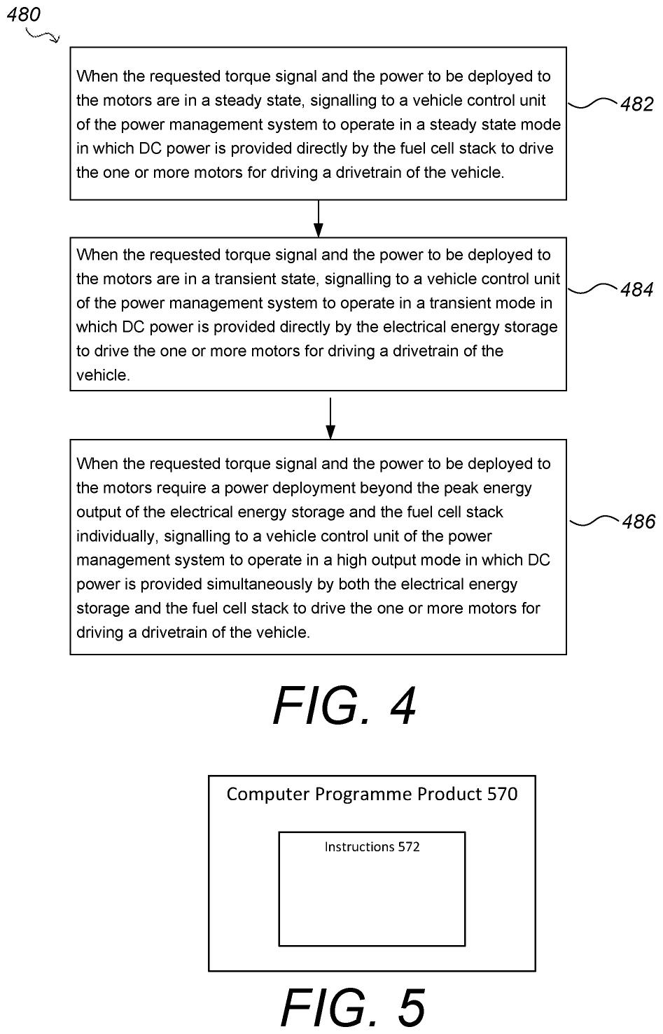

FIG. 4 shows a method 480 of managing the supply of power to one or more motors for driving a fuel cell electric vehicle in accordance with an example of the present disclosure.

The method 480 comprises, when the requested torque signal and the power to be deployed to the motors are in a steady state, signalling 482 to a vehicle control unit 122 of the power management system 250 to operate in a steady state mode in which DC power is provided directly by the fuel cell stack 114 to drive the one or more motors 118 for driving a drivetrain of the vehicle. In the signalled steady state mode, the power management system 250 may simultaneously draw no DC power from the electrical energy store 112 to supply power to one or more motors 118.

The method further comprises, when the requested torque signal and the power to be deployed to the motors are in a transient state, signalling 484 to the vehicle control unit 122 to operate in a transient mode in which DC power is provided directly by the electrical energy store 112 to drive the one or more motors 118 for driving a drivetrain of the vehicle. In the signalled transient mode, the power management system 250 may simultaneously provide DC power from the fuel cell stack 114 to the electrical energy store 112 to charge the electrical energy store 112.

The method further comprises, when the requested torque signal and the power to be deployed to the motors require a power deployment beyond the peak energy output of the electrical energy store 112 and the fuel cell stack 114 individually, signalling 486 to the vehicle control unit 122 to operate in a high output mode in which DC power is provided simultaneously by both the electrical energy store 112 and the fuel cell stack 114 to drive the one or more motors 118 for driving a drivetrain of the vehicle.

Whilst the method steps 482, 484, 486 are shown as being sequential, the method steps may be performed in any order. Moreover, a plurality of one or more of the steps 482, 484, 486 may be performed.

The fuel cell electric vehicle may be fuel cell electric vehicle 360 of FIG. 3. The motors may be motors 118 of FIG. 1. The vehicle control unit may be vehicle control unit 122 of FIG. 1. The power management system may be power management system 250 of FIG. 2. The fuel cell stack may be fuel cell stack 114 of FIG. 1. The electrical energy store may be electrical energy store 112 of FIG. 1.

FIG. 5 shows a computer programme product 570 in accordance with an example of the present disclosure. The computer programme product 570 comprises instructions 572 for configuring the vehicle control unit 122 of FIG. 1, FIG. 2 or FIG. 3 to operate the method 480 of FIG. 4 in the fuel cell electric vehicle 360 of FIG. 3.

The computer programme product 570 may further comprise instructions, or may be connected or connectable to a testing module carrying instructions, to provide a vehicle control calibration tool to allow configuration of the VCU 122. The computer programme product 570 may further comprise instructions, or may be connected or connectable to a testing module carrying instructions, to provide a Data Analysis Tool for recording and viewing specific aspects of the operation of the high voltage power management module 100, power management system 250 and/or fuel cell electric vehicle 360 to assist with calibration of the VCU 122. The computer programme product 570 may further comprise instructions, or may be connected or connectable to a testing module carrying instructions, to provide a Live View Tool to display and monitor live values from the VCU 122, high voltage power management module 100 and/or electrical energy store 112.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. In particular, any dependent claims may be combined with any of the independent claims and any of the other dependent claims.

There now follows a series of numbered clauses defining further examples of the disclosure:

1. A high voltage power management module for supplying power to one or more motors for driving a fuel cell electric vehicle:
an E-Machine interface subsystem for exchanging DC power with an inverter configured to provide AC power to one or more motors for driving a drivetrain of the vehicle;
a storage interface subsystem to exchange DC power with an electrical energy store for providing transient power to drive the fuel cell electric vehicle;
a fuel cell interface subsystem for receiving DC power from a fuel cell stack of the vehicle configured to directly drive the one or more motors through the E-Machine interface subsystem of the high voltage power management module;
a switching module configured to direct the voltage between the DC power of the storage interface subsystem, the fuel cell interface subsystem and the E-Machine interface subsystem, wherein the switching module is configured to be operable to rapidly switch between or simultaneously combine DC power from the storage interface subsystem and the fuel cell interface subsystem to provide DC power to the E-Machine interface subsystem to drive the one or more motors for driving a drivetrain of the vehicle; and
control circuitry coupled to the switching module to control the switching module to select or combine a source of DC power from the electrical energy store and the fuel cell stack to provide DC power to the E-Machine interface subsystem.

2. A DC-DC converter comprising a high voltage power management module as in clause 1,
wherein the switching module is further configured to step the voltage between the DC power of the storage interface subsystem, the fuel cell interface subsystem and the E-Machine interface subsystem, and to be operable to rapidly switch between or simultaneously combine DC power from the storage interface subsystem and the fuel cell interface subsystem to provide converted DC power to the E-Machine interface subsystem to drive the one or more motors for driving a drivetrain of the vehicle; and
wherein the control circuitry is further configured to control the switching module to select or combine a source of DC power from the electrical energy store and the fuel cell stack to provide converted DC power to the E-Machine interface subsystem.

3. An electrical energy store for use with a high voltage power management module as in clause 1 for supplying power to one or more motors for driving a fuel cell electric vehicle or a DC-DC converter as in clause 2, the electrical energy store being configured to have: a maximum charge capacity, and
a peak deployable output power such that, when operating at peak deployable output, the electrical energy store is discharged from its maximum charge capacity to depletion in less than 5 minutes.

4. A vehicle control unit, VCU, for use with a high voltage power management module as in clause 1 or a DC-DC converter as in clause 2, the VCU having:
an input to receive a torque signal indicative of a requested torque to be provided to a drivetrain of the vehicle;
an output to provide control signals to a high voltage power management module as in clause 1 or a DC-DC converter as in clause 2; and
a control module configured to provide at the output control signals for the high voltage power management module or DC-DC converter indicating whether to select or combine a source of power from the electrical energy store and the fuel cell stack to provide DC power to the E-Machine interface subsystem.

5. A power management system for supplying power to one or more motors for driving a fuel cell electric vehicle, the system comprising:
a high voltage power management module as in clause 1 or a DC-DC converter as in clause 2;
an electrical energy store as in clause 3; and
a vehicle control unit as in clause 4.

6. A fuel cell electric vehicle comprising:
a power management system as in clause 5; and a fuel cell stack coupled to the high voltage power management module or DC-DC converter, the high voltage power management module or DC-DC converter to provide DC power from the fuel cell stack to drive the one or more motors of the vehicle for driving a drivetrain of the vehicle.

7. A high voltage power management module as in clause 1, DC-DC converter as in clause 2, power management system as in clause 5, or fuel cell electric vehicle as in clause 6, wherein the switching module is further configured to be operable to provide DC power from the fuel cell interface subsystem to the storage interface subsystem to charge the electrical energy store.

8. A high voltage power management module as in clause 1 or 7, DC-DC converter as in clause 2 or 7, power management system as in clause 5 or 7, or fuel cell electric vehicle as in clause 6 or 7, wherein the switching module is further configured to be operable to provide DC power recovered from the from the E-Machine interface subsystem to the storage interface subsystem to charge the electrical energy store.

9. An electrical energy store as in clause 3, power management system as in clause 5, 7 or 8, or fuel cell electric vehicle as in clause 6, 7 or 8, wherein the electrical energy store is sized such that the total energy providable to the one or more motors for driving the fuel cell electric vehicle by discharging the electrical energy store from its maximum charge capacity to depletion is an order of magnitude less than the total energy providable by the fuel cell stack from a fuel store in the vehicle in normal use.

10. An electrical energy store as in clause 3 or 9, power management system as in any of clauses 5 or 7 to 9, or fuel cell electric vehicle as in any of clauses 6 to 9, wherein the peak deployable output power from the electrical energy store is greater than the peak deployable output power from the fuel cell stack, optionally at least 1.25 times greater, optionally at least 1.5 times greater, optionally at least 1.75 times greater, optionally at least 2.00 times greater.

11. An electrical energy store as in clause 3, 9 or 10, power management system as in any of clauses 5 or 7 to 10, or fuel cell electric vehicle as in any of clauses 6 to 10, wherein the electrical energy store is configured to have a maximum voltage of at least 700V.

12. An electrical energy store as in any of clauses 3 or 9 to 11, power management system as in any of clauses 5 or 7 to 11, or fuel cell electric vehicle as in any of clauses 6 to 11, wherein the weight of the electrical energy store is less than 15% of the kerb weight of the fuel cell electric vehicle.

13. A power management system as in any of clauses 5 or 7 to 12, or fuel cell electric vehicle as in any of clauses 6 to 12, wherein the fuel cell stack is sized such that the peak deployable output power of the fuel cell stack is sufficient to solely drive the one or more motors of the vehicle for driving the drivetrain of the vehicle in intended normal driving operation for the vehicle without relying on output power from the electrical energy store, wherein optionally the output of the fuel cell stack is at least 75 KW, optionally at least 100 KW, optionally at least 125 KW, optionally at least 150 KW.

14. A power management system as in any of clauses 5 or 7 to 13, or fuel cell electric vehicle as in any of clauses 6 to 13, wherein the fuel cell stack is divided into multiple separately operable fuel cell sub-stacks, the VCU, high voltage power management module or DC-DC converter being configured to cause the sub-stacks to be activated in order to provide required DC power to drive the drivetrain of the vehicle based on the requested torque signal.

15. A vehicle control unit as in clause 4, a power management system as in any of clauses 5 or 7 to 14, or fuel cell electric vehicle as in any of clauses 6 to 14, wherein the control module is configured to provide at the output control signals for the high voltage power management module or DC-DC converter indicating whether to select or combine a source of power from the electrical energy store and the fuel cell stack to provide DC power to the E-Machine interface subsystem.

16. A vehicle control unit as in clause 4 or 15, a power management system as in any of clauses 5 or 7 to 15, or fuel cell electric vehicle as in any of clauses 6 to 15, wherein the control module is configured to generate a control signal for outputting to the high voltage power management module or DC-DC converter based on the requested torque signal, the control signal configuring the high voltage power management module or DC-DC converter, fuel cell stack and electrical energy store to operate in a mode selected from a group comprising one or more of:
a steady state mode in which DC power is provided directly by the fuel cell stack to drive the one or more motors for driving a drivetrain of the vehicle to optimise the power management system for a scenario in which the requested torque and the power to be deployed to the motors are in a steady state, optionally in which no DC power is simultaneously provided by the electrical energy store;
a transient mode in which DC power is provided directly by the electrical energy store to drive the one or more motors for driving a drivetrain of the vehicle to optimise the power management system for a scenario in which the requested torque and the power to be deployed to the motors are in a transient state, optionally in which DC power is simultaneously provided by the fuel cell stack to the electrical energy store to charge the electrical energy store; and
a high output mode in which DC power is provided simultaneously by both the electrical energy store and the fuel cell stack to drive the one or more motors for driving a drivetrain of the vehicle to optimise the power management system for a scenario in which the requested torque and the power to be deployed to the motors require a power deployment beyond the peak energy output of the electrical energy store and the fuel cell stack individually.

17. A method of managing the supply of power to one or more motors for driving a fuel cell electric vehicle as in any of clauses 6 to 16, comprising:
when the requested torque signal and the power to be deployed to the motors are in a steady state, signalling to a vehicle control unit of the power management system to operate in a steady state mode in which DC power is provided directly by the fuel cell stack to drive the one or more motors for driving a drivetrain of the vehicle;
when the requested torque signal and the power to be deployed to the motors are in a transient state, signalling to a vehicle control unit of the power management system to operate in a transient mode in which DC power is provided directly by the electrical energy store to drive the one or more motors for driving a drivetrain of the vehicle;
when the requested torque signal and the power to be deployed to the motors require a power deployment beyond the peak energy output of the electrical energy store and the fuel cell stack individually, signalling to a vehicle control unit of the power management system to operate in a high output mode in which DC power is provided simultaneously by both the electrical energy store and the fuel cell stack to drive the one or more motors for driving a drivetrain of the vehicle.

18. A method as in clause 17, wherein in the signalled steady state mode, the power management system simultaneously draws no DC power from the electrical energy store to supply power to one or more motors.

19. A method as in clause 17 or 18, wherein in the signalled transient mode, the power management system simultaneously provides DC power from the fuel cell stack to the electrical energy store to charge the electrical energy store.

20. A computer programme product carrying instructions for configuring a vehicle control unit as in clause 4 to operate the methods of any of clauses 17 to 19 in a fuel cell electric vehicle as in clause 6.

1. An apparatus for supplying power to one or more motors for driving a drivetrain of a fuel cell electric vehicle, the power management system comprising:
an electrical energy store configured to selectively supply power to the one or more motors to provide transient power to drive the fuel cell electric vehicle; and
a high voltage power management module connectable to a fuel cell stack of the fuel cell vehicle, the high voltage power management module configured to control the fuel cell stack and the electrical energy store to alternatively or simultaneously supply power to the one or more motors;
wherein the electrical energy store is configured to have a maximum charge capacity, and a peak deployable output power such that, when operating at peak deployable output, the electrical energy store is discharged from its maximum charge capacity to depletion in less than 7 minutes.

2. The apparatus according to claim 1, wherein the electrical energy store is configured to have a greater peak deployable output power than a peak deployable output power of the fuel cell stack, and wherein the electrical energy store is sized such that the total energy providable to the one or more motors for driving the fuel cell electric vehicle by discharging the electrical energy store from its maximum charge capacity to depletion is less than the total energy providable by the fuel cell stack from a fuel store in the vehicle in normal use.

3. An apparatus for supplying power to one or more motors for driving a drivetrain of a fuel cell electric vehicle, the power management system comprising:
an electrical energy store configured to selectively supply power to the one or more motors to provide transient power to drive the fuel cell electric vehicle; and
a high voltage power management module connectable to a fuel cell stack of the fuel cell vehicle, the high voltage power management module configured to control the fuel cell stack and the electrical energy store to alternatively or simultaneously supply power to the one or more motors;
wherein the electrical energy store is configured to have a greater peak deployable output power than a peak deployable output power of the fuel cell stack, and wherein the electrical energy store is sized such that the total energy providable to the one or more motors for driving the fuel cell electric vehicle by discharging the electrical energy store from its maximum charge capacity to depletion is less than the total energy providable by the fuel cell stack from a fuel store in the vehicle in normal use.

4. The apparatus according to claim 3, wherein the electrical energy store is configured to have a maximum charge capacity, and a peak deployable output power such that, when operating at peak deployable output, the electrical energy store is discharged from its maximum charge capacity to depletion in less than 7 minutes.

5. canceled

6. The apparatus according to claim 2, wherein the peak deployable output power from the electrical energy store is greater than the peak deployable output power from the fuel cell stack, optionally at least 1.25 times greater, optionally at least 1.5 times greater, optionally at least 1.75 times greater, optionally at least 2.00 times greater.

7. The apparatus according to claim 2, wherein the electrical energy store is configured to have a maximum voltage of at least 700V.

8. The apparatus according to claim 2, wherein the weight of the electrical energy store is less than 15% of the kerb weight of the fuel cell electric vehicle.

9. The apparatus according to claim 2; and
a high voltage power management module comprising:
an E-Machine interface subsystem for exchanging DC power with an inverter configured to provide AC power to the one or more motors for driving a drivetrain of the vehicle;
a storage interface subsystem to exchange DC power with the electrical energy store for providing transient power to drive the fuel cell electric vehicle;
a fuel cell interface subsystem for receiving DC power from the fuel cell stack of the vehicle configured to directly drive the one or more motors through the E-Machine interface subsystem of the high voltage power management module;
a switching module configured to direct the voltage between the DC power of the storage interface subsystem, the fuel cell interface subsystem and the E-Machine interface subsystem, wherein the switching module is configured to be operable to switch between or simultaneously combine DC power from the storage interface subsystem and the fuel cell interface subsystem to provide DC power to the E-Machine interface subsystem to drive the one or more motors for driving a drivetrain of the vehicle; and
control circuitry coupled to the switching module to control the switching module to select or combine a source of DC power from the electrical energy store and the fuel cell stack to provide DC power to the E-Machine interface subsystem.

10. The apparatus according to claim 9, wherein the switching module is further configured to be operable to provide DC power from the fuel cell interface subsystem to the storage interface subsystem to charge the electrical energy store.

11. The apparatus according to claim 2, wherein the switching module is further configured to be operable to provide DC power recovered from the from the E-Machine interface subsystem to the storage interface subsystem to charge the electrical energy store.

12. The apparatus according to claim 2, further comprising a DC-DC converter comprising the high voltage power management module,
wherein the switching module is further configured to step the voltage between the DC power of the storage interface subsystem, the fuel cell interface subsystem and the E-Machine interface subsystem, and to be operable to switch between or simultaneously combine DC power from the storage interface subsystem and the fuel cell interface subsystem to provide converted DC power to the E-Machine interface subsystem to drive the one or more motors for driving a drivetrain of the vehicle; and
wherein the control circuitry is further configured to control the switching module to select or combine a source of DC power from the electrical energy store and the fuel cell stack to provide converted DC power to the E-Machine interface subsystem.

13. The apparatus according to claim 2, further comprising a vehicle control unit, VCU, the VCU having:
an input to receive a torque signal indicative of a requested torque to be provided to a drivetrain of the vehicle;
an output to provide control signals to a high voltage power management module or the DC-DC converter; and
a control module configured to provide at the output control signals for the high voltage power management module or DC-DC converter indicating whether to select or combine a source of power from the electrical energy store and the fuel cell stack to provide DC power to the E-Machine interface subsystem.

14. The apparatus according to claim 2, further comprising a fuel cell stack coupled to the high voltage power management module or DC-DC converter, the high voltage power management module or DC-DC converter to provide DC power from the fuel cell stack to drive the one or more motors of the vehicle for driving a drivetrain of the vehicle.

15. A fuel cell electric vehicle comprising:
the apparatus as claimed in claim 2; and
a fuel cell stack coupled to the high voltage power management module or DC-DC converter, the high voltage power management module or DC-DC converter to provide DC power from the fuel cell stack to drive the one or more motors of the vehicle for driving a drivetrain of the vehicle.

16. The apparatus as claimed in claim 2, wherein the fuel cell stack is sized such that the peak deployable output power of the fuel cell stack is sufficient to solely drive the one or more motors of the vehicle for driving the drivetrain of the vehicle in intended normal driving operation for the vehicle without relying on output power from the electrical energy store, wherein optionally the output of the fuel cell stack is at least 75 KW, optionally at least 100 KW, optionally at least 125 KW, optionally at least 150 KW.

17. The apparatus as claimed in claim 2, wherein the fuel cell stack is divided into multiple separately operable fuel cell sub-stacks, the VCU, high voltage power management module or DC-DC converter being configured to cause the sub-stacks to be activated in order to provide required DC power to drive the drivetrain of the vehicle based on the requested torque signal.

18. An apparatus as claimed in claim 2, wherein the control module is configured to generate a control signal for outputting to the high voltage power management module or DC-DC converter based on the requested torque signal, the control signal configuring the high voltage power management module or DC-DC converter, fuel cell stack and electrical energy store to operate in a mode selected from a group comprising one or more of:
a steady state mode in which DC power is provided directly by the fuel cell stack to drive the one or more motors for driving a drivetrain of the vehicle to optimise the power management system for a scenario in which the requested torque and the power to be deployed to the motors are in a steady state, optionally in which no DC power is simultaneously provided by the electrical energy store;
a transient mode in which DC power is provided directly by the electrical energy store to drive the one or more motors for driving a drivetrain of the vehicle to optimise the power management system for a scenario in which the requested torque and the power to be deployed to the motors are in a transient state, optionally in which DC power is simultaneously provided by the fuel cell stack to the electrical energy store to charge the electrical energy store; and
a high output mode in which DC power is provided simultaneously by both the electrical energy store and the fuel cell stack to drive the one or more motors for driving a drivetrain of the vehicle to optimise the power management system for a scenario in which the requested torque and the power to be deployed to the motors require a power deployment beyond the peak energy output of the electrical energy store and the fuel cell stack individually.

19. A method of managing the supply of power to one or more motors for driving a fuel cell electric vehicle as claimed in claim 2, comprising:
when the requested torque signal and the power to be deployed to the motors are in a steady state, signalling to a vehicle control unit of the power management system to operate in a steady state mode in which DC power is provided directly by the fuel cell stack to drive the one or more motors for driving a drivetrain of the vehicle;
when the requested torque signal and the power to be deployed to the motors are in a transient state, signalling to a vehicle control unit of the power management system to operate in a transient mode in which DC power is provided directly by the electrical energy store to drive the one or more motors for driving a drivetrain of the vehicle; and
when the requested torque signal and the power to be deployed to the motors require a power deployment beyond the peak energy output of the electrical energy store and the fuel cell stack individually, signalling to a vehicle control unit of the power management system to operate in a high output mode in which DC power is provided simultaneously by both the electrical energy store and the fuel cell stack to drive the one or more motors for driving a drivetrain of the vehicle.

20. A method as claimed in claim 19, wherein in the signalled steady state mode, the power management system simultaneously draws no DC power from the electrical energy store to supply power to one or more motors.

21. A method as claimed in claim 2, wherein in the signalled transient mode, the power management system simultaneously provides DC power from the fuel cell stack to the electrical energy store to charge the electrical energy store.

22. A computer programme product carrying instructions for configuring an apparatus as claimed in claim 2.

23. A computer programme product carrying instructions to operate the method of claim 19.
